(19) United States
(12) Patent Application Publication
(10) Pub. No.: US 2025/0371994 A1
(43) Pub. Date: Dec. 4, 2025

(54) SIMULATION MACHINE AND ITS SOMATOSENSORY SIMULATION DEVICES

(71) Applicant: INTERNATIONAL GAMES SYSTEM CO., LTD., New Taipei City (TW)

(72) Inventor: Yen Chung LIU, New Taipei City (TW)

(21) Appl. No.: 18/797,481

(22) Filed: Aug. 7, 2024

(30) Foreign Application Priority Data
May 31, 2024 (CN) 202410699418.X

(51) Int. Cl. G09B 9/04

(52) U.S. Cl. CPC G09B 9/04

(57) ABSTRACT

A somatosensory simulation device includes a base, a first steering portion having a bracket and an extension portion, a second steering portion having a loading frame, a clamping assembly, a first motive power device connected to the base and the clamping assembly for driving the clamping assembly to clamp and unclamp the extension portion, and a second motive power device connected to the base and the bracket for rotating the bracket. The bracket is pivotally connected to the base. The extension portion is connected to the bracket to extend to the base. The loading frame is pivotally connected to one side of the bracket opposite to the base so that the loading frame can rotate about a second axial direction intersecting the second axial direction. The clamping assembly is movably located on the base for clamping the extension portion.

### CROSS-REFERENCE TO RELATED APPLICATION

This application claims priority to China Application Serial Number 202410699418.X, filed May 31, 2024, which is herein incorporated by reference.

### BACKGROUND

### Field of Invention

The present disclosure relates to a somatosensory simulation device. More particularly, the present disclosure relates to a somatosensory simulation device of a simulation machine that simulates tilting and skidding postures.

### Description of Related Art

Nowadays, riding and racing simulators can simulate the actual feeling of riding a bicycle to train operators to control the motorcycle. For example, most of the above-mentioned simulation machines use a steering mechanism or a tilting car body to simulate the steering of the car body.

However, the above-mentioned simulation machine cannot naturally and smoothly resume the car body to the somatosensory posture before tilting after special postures such as stunt flicks and other control methods. Thus, a shortcoming of limited simulation realism and fluency is occurred so as to hinder the interaction between the game machine and the operator. Therefore, the above-mentioned technologies obviously still have inconveniences and defects, which are issues that the industry needs to solve urgently.

### SUMMARY

One aspect of the present disclosure is to provide a simulation machine and its somatosensory simulation device for solving the difficulties mentioned above in the prior art.

In one embodiment of the present disclosure, a somatosensory simulation device includes a base, a first steering portion, a second steering portion, a clamping assembly, a first motive power device and a second motive power device. The first steering portion includes a bracket, a first pivot portion and an extension portion. The bracket is pivotally connected to the base through the first pivot portion so that the bracket is able to rotate about a first axial direction parallel to a gravity direction, and the extension portion is connected to the bracket and extends towards the base. The second steering portion includes a loading frame and a second pivot portion. The loading frame is pivotally connected to one side of the bracket opposite to the base through the second pivot portion so that the loading frame is able to rotate about a second axial direction intersecting the second axial direction. The clamping assembly is movably located on the base for clamping the extension portion. The first motive power device is connected to the base and the clamping assembly for driving the clamping assembly to clamp and unclamp the extension portion. The second motive power device is connected to the base and the bracket for rotating the bracket.

In one embodiment of the present disclosure, a somatosensory simulation device provided includes a base, a first steering portion, a second steering portion, a clamping assembly, a first motive power device and a second motive power device. The first steering portion includes a bracket having a frame plate and a platform, a first pivot portion pivotally connected to the base, and an extension portion, one end of the frame plate is fixedly connected to the first pivot portion, so that the frame plate is able to rotate about a first axial direction parallel to a gravity direction through the first pivot portion, the platform that is connected to one side of the frame plate opposite to the base, and the platform that is provided with an inclined surface at one side of the platform opposite to the base, and the extension portion that is connected to the other end of the frame plate and extending towards the base. The second steering portion includes a loading frame and a second pivot portion. The loading frame is pivotally connected to the inclined surface of the platform so that the loading frame is able to rotate about a second axial direction that is parallel to the inclined surface. The clamping assembly is movably located on the base for clamping the extension portion. The first motive power device is connected to the base and the clamping assembly for driving the clamping assembly to clamp and unclamp the extension portion. The second motive power device is connected to the base and the frame plate for rotating the bracket.

In one embodiment of the present disclosure, a simulation machine provided includes a vehicle body, a display unit, a motorbike controlling circuit, a processing host and the aforementioned somatosensory simulation device. The vehicle body is fixedly installed on the loading frame. The display unit is installed on the vehicle body. The motorbike controlling circuit is installed on the vehicle body. The processing host is electrically connected to the display unit, the motorbike controlling circuit, the first motive power device and the second motive power device. When a specific condition of a simulation program of the processing host is established, the processing host instructs the first motive power device to synchronously unclamp the clamping assembly to release the extension portion, and instructs the second motive power device to rotate the bracket so that the vehicle body is allowed to present with a tilting and skidding posture.

Thus, through the construction of the embodiments above, the simulation machine and its somatosensory simulation device of the disclosure are able to provide more natural and smoother body-sensory posture when simulating tilting and skidding postures, thereby advancing the realism and fluency of its simulation so as to improve the interaction between the game machine and the operator.

The above description is merely used for illustrating the problems to be resolved, the technical methods for resolving the problems and their efficacies, etc. The specific details of the present disclosure will be explained in the embodiments below and related drawings.

Compared with the prior art, the present disclosure has obvious advantages and beneficial effects.

The simulation machine and its somatosensory simulation device in this disclosure provides a more natural and smooth body-sensory posture when simulating tilting and skidding postures, improves the realism and fluency of its simulation, and enhances the interaction between the game console and the operator.

The above description is only an overview of the technical solution of the present disclosure. In order to understand the technical means of the present disclosure, and implement the technical means according to the content of the description, and in order to make the above and other objects, features and advantages of the present disclosure more obvious and understandable, preferred embodiments are specifically cited below and described in detail with reference to the accompanying drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of a somatosensory simulation device according to one embodiment of the present disclosure.

FIG. 2 is a side view of the somatosensory simulation device of FIG. 1.

FIG. 3 is an exploded view of the somatosensory simulation device of FIG. 1.

FIG. 4 is a cross-sectional view taken along a line A-A viewed in FIG. 1.

FIG. 5 is a top view of a clamping assembly and a first motive power device of FIG. 1.

FIG. 6 is an operational schematic view of the first motive power device of FIG. 5, which drives the clamping assembly to release the extension portion.

FIG. 7A and FIG. 7B are operational schematic views of the somatosensory simulation device of FIG. 1, which rotates the first steering portion, respectively.

FIG. 8A to FIG. 8C are continually operational schematic views of a simulation machine using the somatosensory simulation device of FIG. 1, respectively.

FIG. 9A and FIG. 9B are schematic diagrams of the state of FIG. 8B and FIG. 8C, respectively.

FIG. 10 is a block diagram of a simulation machine according to one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

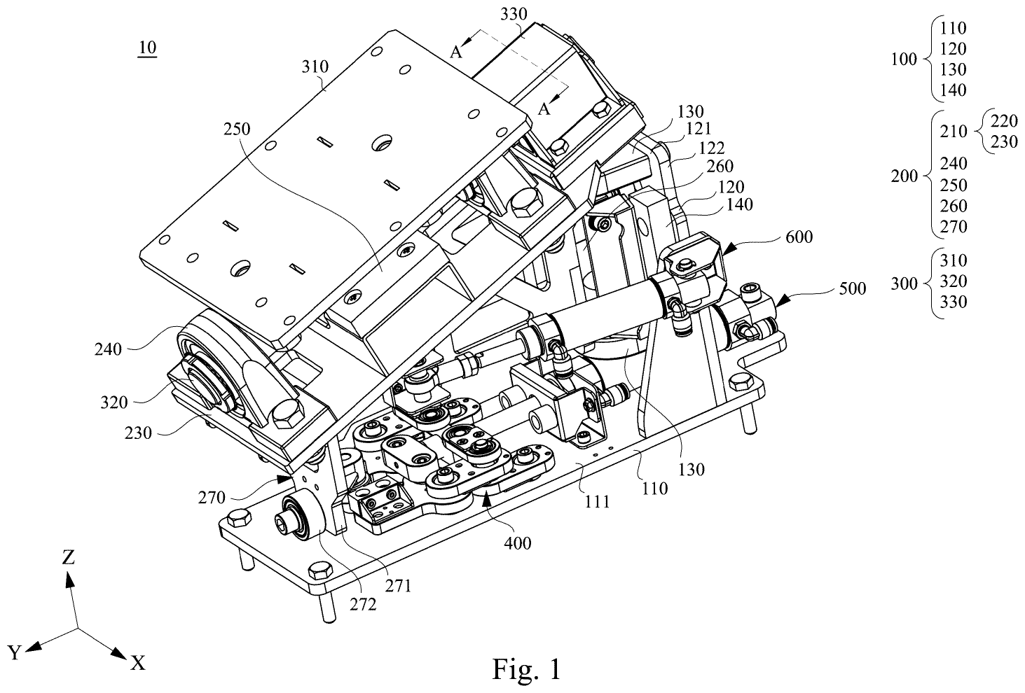

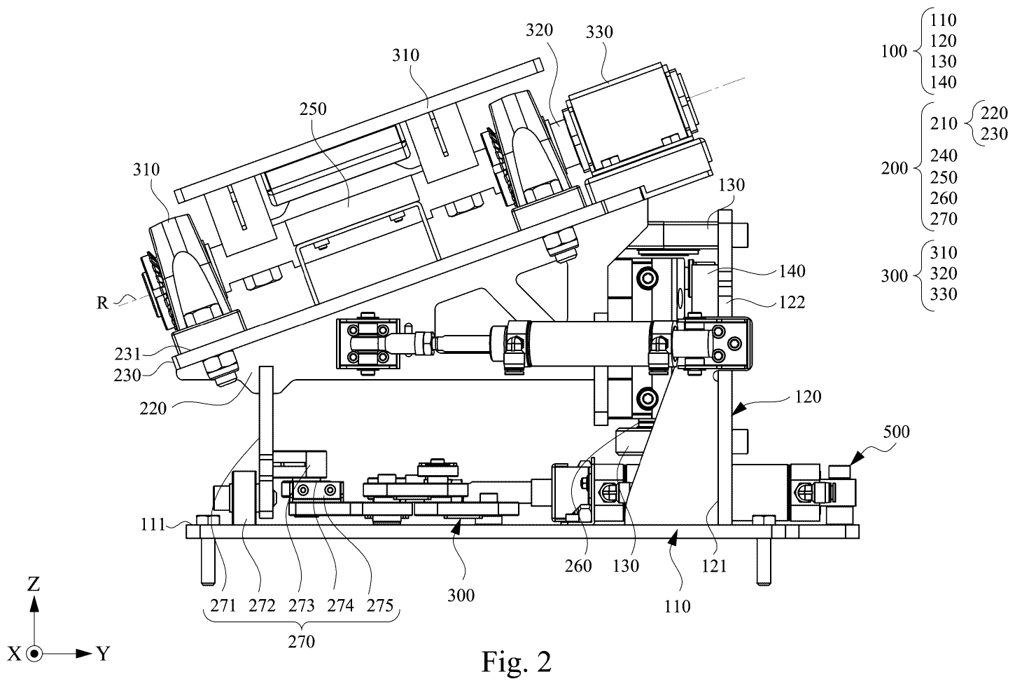

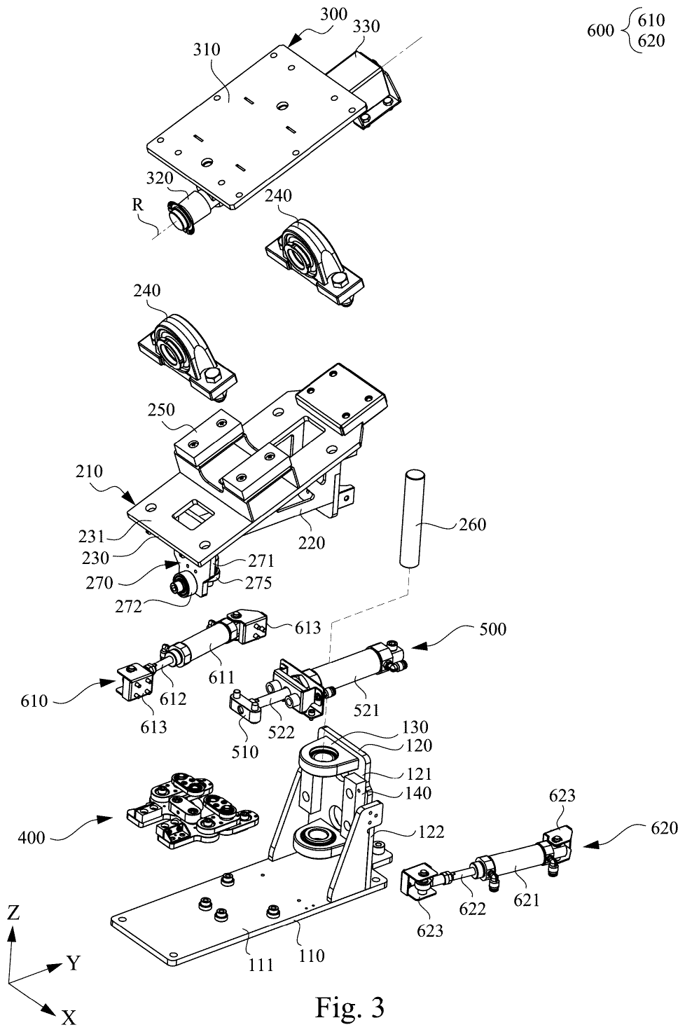

Reference is now made to FIG. 1 to FIG. 3, in which FIG. 1 is a perspective view of a somatosensory simulation device 10 according to one embodiment of the present disclosure. FIG. 2 is a side view of the somatosensory simulation device 10 of FIG. 1. FIG. 3 is an exploded view of the somatosensory simulation device 10 of FIG. 1. In this embodiment, as shown in FIG. 1 to FIG. 3, the somatosensory simulation device 10 includes a base 100, a first steering portion 200, a second steering portion 300, a clamping assembly 400, a first motive power device 500 and a second motive power device 600. The first steering portion 200 includes a bracket 210, a first pivot portion 260 and an extension portion 270. The bracket 210 is fixedly connected to the first pivot portion 260, and pivotally connected to the base 100 through the first pivot portion 260. Thus, the bracket 210 of the first steering portion 200 is able to repeatedly rotate (or swing) about a first axial direction (e.g., Z axis) parallel to a gravity direction (e.g., Z axis). The extension portion 270 is connected to the bracket 210, disposed opposite to the first pivot portion 260, and extends from the bracket 210 to the base 100 along the first axial direction (e.g., Z axis). The second steering portion 300 includes a loading frame 310 and a second pivot portion 320. The loading frame 310 is fixedly connected to the second pivot portion 320, and pivotally connected to one side of the bracket 210 opposite to the base 100 through the second pivot portion 320. Thus, the second steering portion 300 is able to repeatedly rotate (or swing) about a second axial direction (e.g., R axis) intersecting the first axial direction (e.g., Z axis). The loading frame 310 is used to fixedly install with an external housing. The external housing is, for example, a car body of the simulation machine 700, however, the present disclosure is not limited thereto. The clamping assembly 310 is movably located on the base 100 for clamping the extension portion 270. The first motive power device 500 is connected to the base 100 and the clamping assembly 400 for driving the clamping assembly 400 to clamp and unclamp the extension portion 270. The second motive power device 600 is connected to the base 100 and the bracket 210 for rotating (or swing) the bracket 210.

Specifically, as shown in FIG. 2 and FIG. 3, in the embodiment, the base 100 which is L-shaped is provided with a bottom plate 110 and a vertical plate 120. The bottom plate 110 is fixedly connected to the vertical plate 120, and the bottom plate 110 and the vertical plate 120 are orthogonal to each other. The vertical plate 120 is used for placing the first steering part 200 and the second power device 600. For example, the first turning part 200 is disposed on the inner wall surface 121 of the vertical plate 120 facing the bracket 210. The second power device 600 is disposed on the side 122 of the vertical plate 120. The bottom plate 110 is used for placing the first power device 500 and the clamping assembly 400. For example, the first power device 500 and the clamping assembly 400 are jointly disposed on the top surface 111 of the bottom plate 110 facing towards the bracket 210.

In addition, the vertical plate 120 is further provided with two first pivot-received portions 130 at an inner wall surface 121 thereof, and the first pivot portion 260 is received within these first pivot-received portions 130 so that these first pivot portion 260 can be rotated relatively within the first pivot-received portions 130.

Furthermore, the base 100 further includes two first position-limited portions 140. The first position-limited portions 140 are respectively located on two opposite sides of the first pivot portion 260 for preventing excessive rotation of the bracket 210 so as to limit a rotation range of the bracket 210.

The bracket 210 is provided with an inclined surface 231 at one side of the bracket 210 opposite to the base 100. The inclined surface 231 is used to support the second steering portion 300, and the long axial direction of the inclined surface 231 is parallel to the second axial direction (e.g., R axis). In the embodiment, the bracket 210 includes a frame plate 220 and a platform 230. One end of the frame plate 220 is fixedly connected to the first pivot portion 260, and the other end thereof allows the extension portion 270 to extend toward the base 100, and allows the extension portion 270 to abut against the top surface 111 of the bottom plate 110. The platform 230 is connected to the side of the frame plate 220 facing the bottom plate 110, and the inclined surface 231 is installed with the side of the platform 230 facing the bottom plate 110. The inclined surface 231 is inclined relative to the top surface 111 of the bottom plate 110, that is, the inclined surface 231 is not parallel to the top surface 111 of the bottom plate 110.

In addition, the inclined surface 231 is further provided with two second pivot-received portions 240, and the second pivot portion 320 is received within these second pivot-received portions 320 so that these second pivot portion 320 can be rotated relatively within the second pivot-received portions 240. The bracket 210 further includes two second position-limited portions 250. The second position-limited portions 250 are respectively located on two opposite sides of the second pivot portion 320 for preventing excessive rotation of the loading frame 310 so as to limit a rotation range of the loading frame 310.

More specifically, in this embodiment, the extension portion 270 includes an elongated rib 271 (as a main body of the extension portion 270) and a roller 272. One end of the elongated rib 271 is integrally connected to the bracket 210, and the roller 272 is pivotally connected to the other end of the elongated rib 271. Therefore, the roller 272 can be rotated about a third axial direction (e.g., Y axis) that is orthogonal to the first axial direction (e.g., X axis), and the roller 272 is movably contacted with the bottom plate 110 of the base 100. Thus, when the bracket 210 is rotated about the first axial direction (e.g., Z axis), the roller 272 of the extension portion 270 not only can abut the top surface 111 of the bottom plate 110, but also can roll correspondingly on the top surface 111 of the bottom plate 110, thereby allowing the movement of the first steering portion 200 to be smoother.

Also, the extension portion further includes a lug 273, a pivot shaft 274 and a fixed portion 275. The lug 273 is disposed on the elongated rib 271, and extended outwards from one surface of the elongated rib 271 facing the roller 272 along the third axial direction (e.g., Y axis). The long axial direction of the pivot shaft 274 is parallel to the first axial direction (e.g., Z axis). The fixed portion 275 is pivotally connected to the lug 273 through the pivot shaft 274, so as to be clamped by the clamping assembly 400. The fixed portion 275 is, for example, a wheel body, however, the present disclosure is not limited thereto.

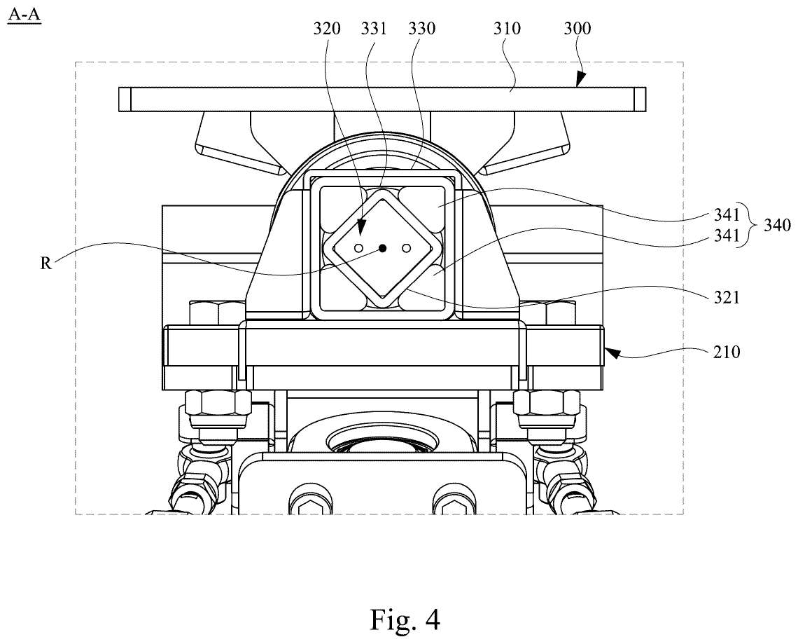

FIG. 4 is a cross-sectional view taken along a line A-A viewed in FIG. 1. As shown in FIG. 2 and FIG. 4, the second steering portion further includes a fixed frame 330 and an elastic restoring member 340. The fixed frame 330 is fixed on the bracket 210. The elastic restoring member 340 is received within the fixed frame 330, surrounds the second pivot portion 320, and is respectively abutted with the second pivot portion 320 and the fixed frame 330. For example, the elastic restoring member 340 includes one or more rubber blocks 341, and these rubber blocks 341 surround the second pivot portion 320 in sequence. The second pivot portion 320 is provided with a plurality of side surfaces 321 adjoined to each other. Each of the rubber blocks 341 is sandwiched between one of the side surfaces 321 and the fixed frame 330 and abuts against the side surface 321 and the inner surface 331 of the fixed frame 330, respectively.

In this way, when the user exerts force to rotate the second pivot portion 320 to squeeze the rubber blocks 341, the rubber blocks 341 therefore store rebound force. On the contrary, when the user no longer exerts force to rotate the second pivot portion 320, the second pivot portion 320 can be returned to its original position through the resilience of the rubber blocks 341 after rotation back to a previous position before rotation.

However, the present disclosure is not limited thereto. In other embodiments, the elastic recovery member 340 may also be a torsion spring, an elastic ring, or other similar components, and the first steering portion 200 may also be equipped with the above-mentioned elastic restoring member 340.

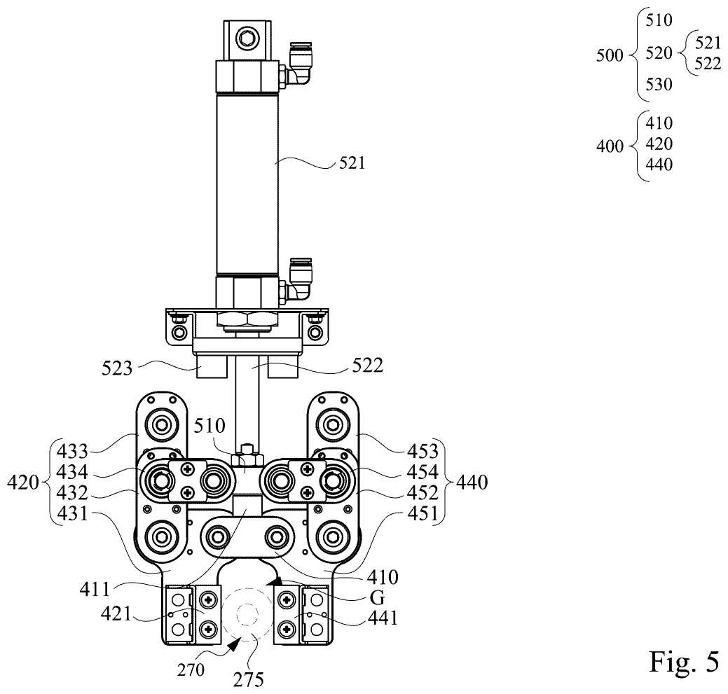

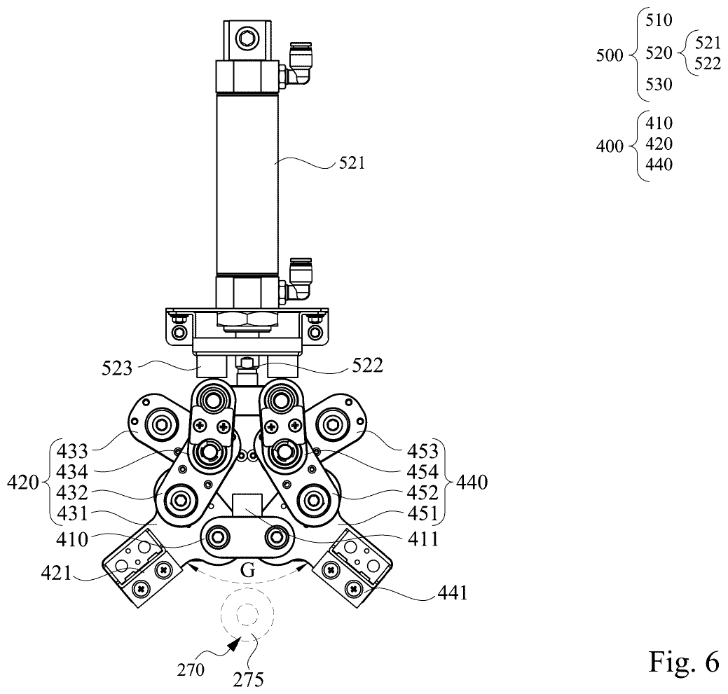

FIG. 5 is a top view of a clamping assembly 400 and a first motive power device 500 of FIG. 1 wherein the clamping assembly 400 is driven to clamp the extension portion 270. FIG. 6 is an operational schematic view of the first motive power device 500 of FIG. 5, which drives the clamping assembly 400 to release the extension portion 270. More specifically, as shown in FIG. 1 and FIG. 5, the clamping assembly 400 includes an auxiliary rod body 410, a left clamping member 420 and a right clamping member 440. The left clamping member 420 is pivotably located on the base 100 for rotating about the first axial direction (e.g., Z axis). The right clamping member 440 is symmetrically located on the base 100 with the left clamping member 420, and pivotably located on the base 100 for rotating about the first axial direction (e.g., Z axis). The auxiliary rod body 410 is jointly pivoted to the left clamping member 420 and the right clamping member 440 for guiding the left clamping member 420 and the right clamping member 440 to swing symmetrically synchronously, and the long axial direction (e.g., X axis) of the auxiliary rod body 410 is orthogonal to the third axial direction (e.g., Y axis).

In this way, as shown in FIG. 5, when the first motive power device 500 drives the left clamping member 420 and the right clamping member 440 to synchronously rotate to approach each other (i.e., in the closed state), the fixed portion 275 is finally and jointly clamped by the left clamping member 420 and the right clamping member 440, thereby preventing the first steering portion 200 from rotating relative to the base 100. On the contrary, as shown in FIG. 6, when the first motive power device 500 drives the left clamping member 420 and the right clamping member 440 to synchronously rotate away from each other (i.e., in expanded state), the fixed portion 275 is finally and jointly unclamped by the left clamping member 420 and the right clamping member 440, thereby allowing the first steering portion 200 to rotate relative to the base 100.

As shown in FIG. 1 to FIG. 3, more specifically, the first steering portion 500 further includes a push rod portion 510 and a telescopic cylinder 520. The push rod portion 510 is pivotally connected to the left clamping member 420 and the right clamping member 440, respectively for driving the left clamping member 420 and the right clamping member 440 to synchronously rotate. A long axial direction (e.g., X axis) of the push rod portion 510 is orthogonal to the third axial direction (e.g., Y axis). The telescopic cylinder 520 includes a cylinder main body 521 and a telescopic shaft 522. One end of the cylinder main body 521 is fixedly connected to the base 100 (e.g., the top surface 111 of the base plate 110). The telescopic shaft 522 is telescopically disposed within the cylinder main body 521, and one end of the telescopic shaft 522 is fixedly connected to the push rod portion 510.

Thus, as shown in FIG. 3 and FIG. 5, when the telescopic shaft 522 extends along the third axial direction to push the push rod portion 510 outwardly, the push rod portion 510 rotates synchronously the left clamping member 420 and the right clamping member 440 to approach each other (i.e., in the closed state) to clamp the fixed portion 275, and the third axial direction (e.g., Y axis) is orthogonal to the first axial direction (e.g., Z axis) and a long axial direction (e.g., X axis) of the push rod portion 510. On the contrary, as shown in FIG. 3 and FIG. 6, when the telescopic shaft 522 retracts along the third axial direction to pull the push rod portion 510 inwardly, the push rod portion 510 rotates synchronously the left clamping member 420 and the right clamping member 440 away from each other (i.e., in expanded state) to unclamp the fixed portion 275.

Furthermore, when the left clamping member 420 and the right clamping member 440 jointly unclamp the fixed portion 275, a stroke interval G can be formed between the left clamping member 420 and the right clamping member 440, and the fixed portion 275 of the first steering portion 200 is still located within the stroke interval G. After the fixed portion 275 of the bracket 210 of the first steering portion 200 is rotated, the fixed portion 275 is still in the stroke interval G. When the left clamping member 420 and the right clamping member 440 are approach to each other (i.e., in closed state), one of the left clamping member 420 and the right clamping member 440 pushes the fixed portion 275 within the stroke interval G back to a position before rotation.

More specifically, in this embodiment, the left clamping member 420 includes a left clamping part 431, a first left connecting rod 432, a second left connecting rod 433 and a left linkage bar 434. One end of the first left connecting rod 432 is pivoted to one end of the second left connecting rod 433, the other end of the first left connecting rod 432 is pivoted to one end of the left clamping part 431, and the other end of the left clamping part 431 is provided with a left buffer pad 421. One end of the left linkage bar 434 is pivoted to one end of the push rod portion 510, and the other end of the left linkage bar 434 is pivoted to the first left connecting rod 432. The first left connecting rod 432 is stacked between the left linkage bar 434 and the second left connecting rod 433. The other end of the second left connecting rod 433 is pivoted to the base 100. The right clamping member 440 includes a right clamping part 451, a first right connecting rod 452, a second right connecting rod 453 and a right linkage bar 454. One end of the first right connecting rod 452 is pivoted to one end of the second right connecting rod 453, the other end of the first right connecting rod 452 is pivoted to one end of the right clamping part 451, and the other end of the right clamping part 451 is provided with a right buffer pad 441. When the left clamping member 420 and the right clamping member 440 are approach to each other (e.g., in closed state), the fixed portion 275 of the extension portion 270 can be directly contacted by the right buffer pad 441 and the left buffer pad 421 therebetween so as to protect the fixed portion 275 from damage. The auxiliary rod body 410 is pivoted to the end of the right clamping part 451 and the end of the left clamping part 431 at the same time. The other end of the second right connecting rod 453 is pivoted to the base 100.

It is noted, the first motive power device 500 further includes a third position-limited portion 523 located on one surface of the cylinder main body 521 facing towards the push rod portion 510. The third position-limited portion 523 is used to stop the push rod portion 510 that is pulled for protecting the push rod portion 510 from damage. The clamping assembly 400 further includes a fourth position-limited portion 411 located on one surface of the auxiliary rod body 410 facing towards the push rod portion 510. The fourth position-limited portion 411 is used to stop the push rod portion 510 that is pushed for protecting the push rod portion 510 from damage.

It is noted, as shown in FIG. 5, when the fixed portion 275 is pushed back to the original position by the clamping assembly 400 (FIG. 1), since the first left connecting rod 432 is orthogonal to the left linkage bar 434, and the first right connecting rod 452 is orthogonal to the right linkage bar 454, a mechanism dead point state will be produced on the clamping assembly 400, which leads the fixed portion 275 to be difficult to be detached from the clamping assembly 400 until the push rod part 510 of the first power device 500 pulls the clamping assembly 400, so that the fixed portion 275 is not easily detached from the clamping assembly 400 until the push rod portion 510 of the first motive power device 500 pulls the left linkage bar 434 and the right linkage bar 454 of the clamping assembly 400, thus, the mechanism dead point state can be cancelled (FIG. 6).

When the first motive power device 500 pulls the clamping assembly 400, since an expanded direction of the clamping assembly 400 is same as a direction of lateral force exerted by the bracket 210, therefore, the bracket 210 can be easily caused to slide sideways, and the clamping assembly 400 cannot be deployed due to lateral force application.

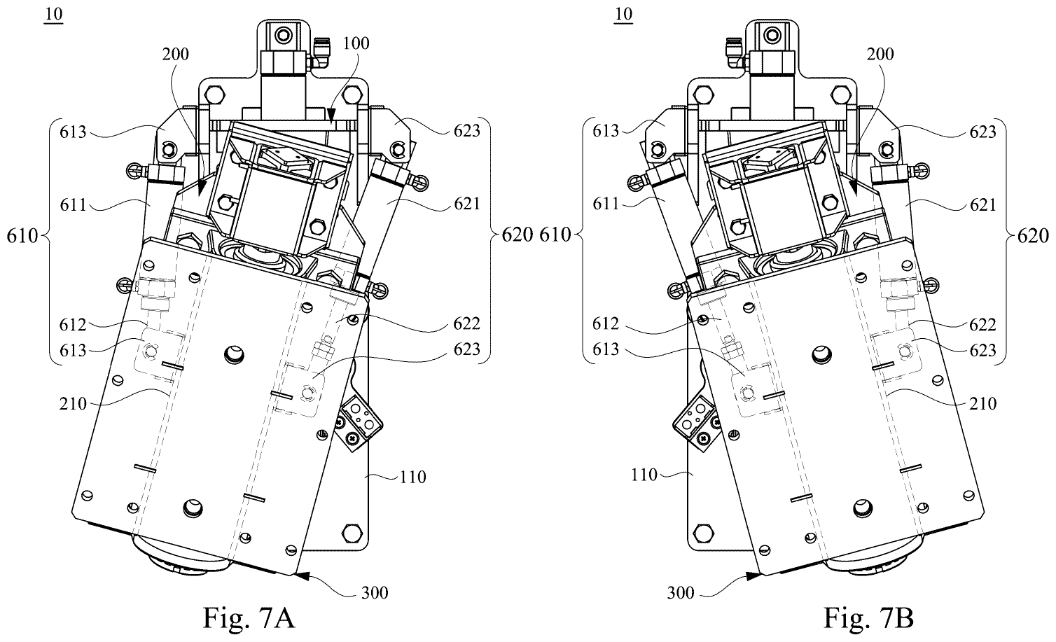

FIG. 7A and FIG. 7B are operational schematic views of the somatosensory simulation device 10 of FIG. 1, which rotates the first steering portion 200, respectively. As shown in FIG. 3 and FIG. 7A, the second motive power device 600 further includes a left driving cylinder 610 and a right driving cylinder 620, and the bracket 210 is disposed between the left driving cylinder 610 and the right driving cylinder 620. Two opposite ends of the left driving cylinder 610 are pivotally connected to the base 100 and the bracket 210 (FIG. 2), respectively.

More specifically, as shown in FIG. 3 and FIG. 7A, the left driving cylinder 610 includes a left cylinder block 611 and a left cylinder shaft 612. One end of the left cylinder block 611 is pivotally connected to the vertical plate 120 of the base 100 through one left pivot portion 613. The left cylinder shaft 612 is telescopically disposed within the left cylinder block 611, and one end of the left cylinder shaft 612 is pivotally connected to the bracket 210 through another left pivot portion 613. The right driving cylinder 620 includes a right cylinder block 621 and a right cylinder shaft 622. One end of the right cylinder block 621 is pivotally connected to the vertical plate 120 of the base 100 through one right pivot portion 623. The right cylinder shaft 622 is telescopically disposed within the right cylinder block 621, and one end of the right cylinder shaft 622 is pivotally connected to the bracket 210 through another right pivot portion 623, and the bracket 210 is the left cylinder block 611 and the right cylinder block 621.

In this way, as shown in FIG. 3 and FIG. 7A, when the right driving cylinder 620 drives the right cylinder shaft 622 to reach out of the right cylinder block 621 and push the bracket 210, and the left driving cylinder 610 drives the left cylinder shaft 612 to retract into the left cylinder block 611 and pull the bracket 210, the bracket 210 is rotated left on the base 100 about the first axial direction (e.g., Z axis) through the first pivot portion 260.

On the contrary, as shown in FIG. 3 and FIG. 7B, when the left driving cylinder 610 drives the left cylinder shaft 612 to reach out of the left cylinder block 611 and push the bracket 210, and the right driving cylinder 620 drives the right cylinder shaft 622 to retract into the right cylinder block 621 and pull the bracket 210, the bracket 210 is rotated right on the base 100 about the first axial direction (e.g., Z axis) through the first pivot portion 260.

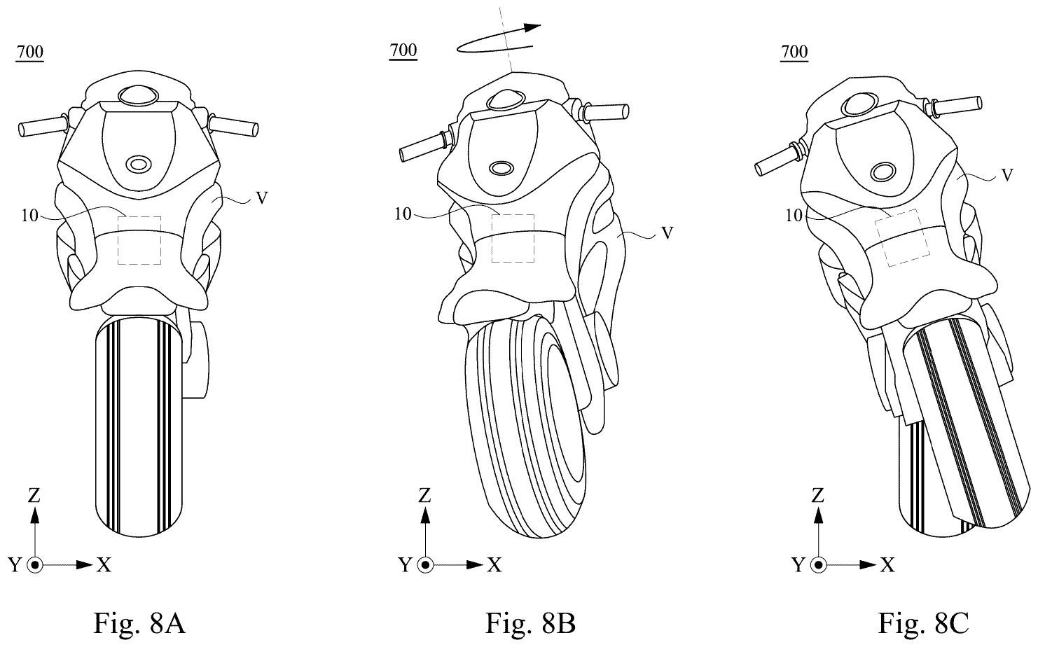

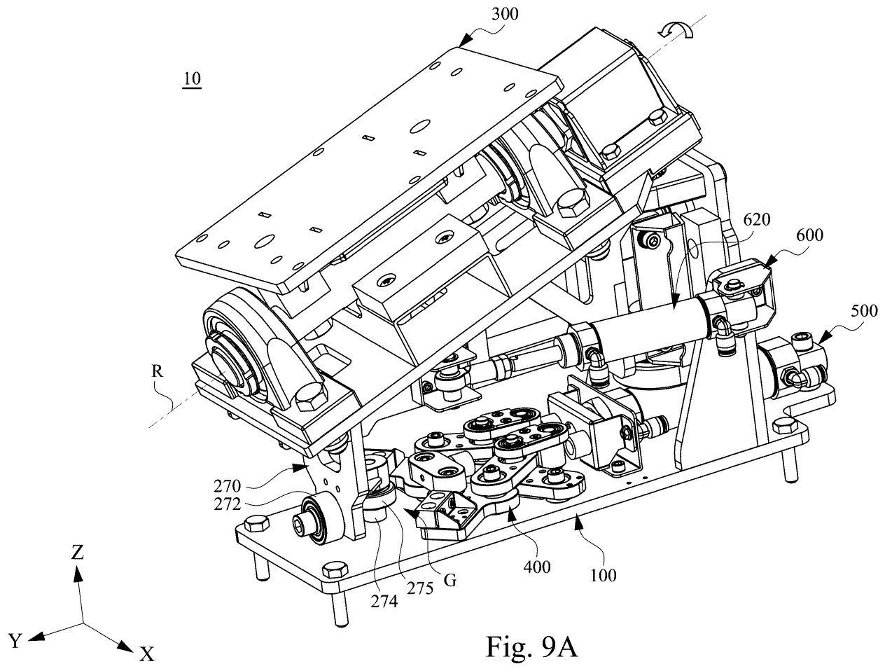

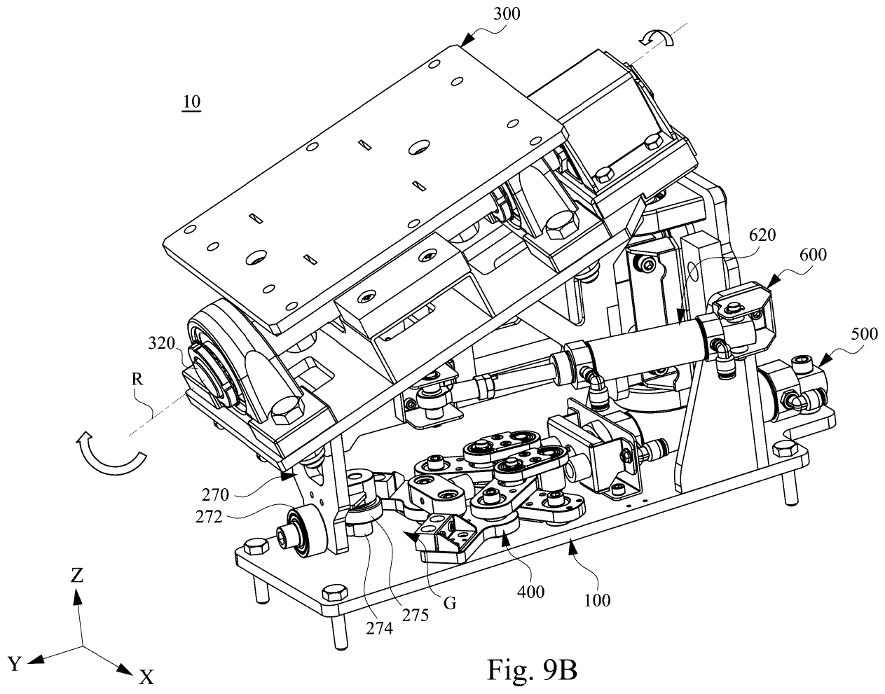

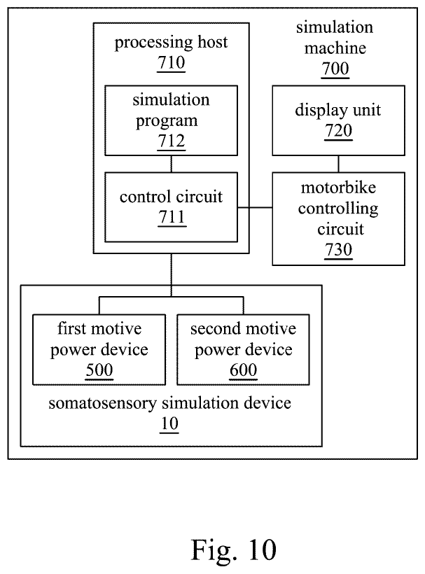

Reference is now made to FIG. 8A to FIG. 10, in which FIG. 8A to FIG. 8C are continually operational schematic views of a simulation machine 700 using the somatosensory simulation device 10 of FIG. 1, respectively, FIG. 9A and FIG. 9B are schematic diagrams of the state of FIG. 8B and FIG. 8C, respectively, and FIG. 10 is a block diagram of a simulation machine 700 according to one embodiment of the present disclosure. In the embodiment, as shown in FIG. 2 and FIG. 8A, the above-mentioned somatosensory simulation device 10 can be adapted to the simulation machine 700 for riding and racing fields, and an outer shell component (e.g., vehicle body V of a racing motorcycle) is fixedly installed on the loading frame 310 (FIG. 1).

As shown in FIG. 10, the simulation machine 700 includes a processing host 710, a display unit 720, and a motorbike controlling circuit 730 (e.g., simulated throttle, gearing and braking). The processing host 710 is electrically connected to the display unit 720, the motorbike controlling circuit 730, the first motive power device 500 and the second motive power device 600 for controlling the display unit 720, the motorbike controlling circuit 730, the first motive power device 500 and the second motive power device 600.

More specifically, the processing host 710 includes a control circuit 711 and a simulation program 712. The control circuit 711 is electrically connected to the display unit 720, the motorbike controlling circuit 730, the first motive power device 500 and the second motive power device 600, and used to control the first motive power device 500 and the second motive power device 600 in response to the simulation program 712. The display unit 720 is installed on the simulation machine 700, and used to display a simulation image provided by the simulation program 712. The display unit 720 and the motorbike controlling circuit 730 are installed on the vehicle body V, respectively. When specific conditions of the simulation program 712 of the processing host 710 are established, the processing host 710 instructs the first motive power device 500 to synchronously expand the clamping assembly 400 to release the extension portion 270 (FIG. 9A) through signals fed back by the rotation angle sensors (not shown) provided on the first pivot portion 260 and the second pivot portion 320, and instructs the second motive power device 600 to rotate bracket 210 (FIG. 9B), so that the vehicle body V is allowed to present with a tilting and skidding posture (FIG. 8C).

More specifically, as shown in FIG. 8A, when the vehicle body V is in an upright position, an operator can straddle the simulation machine 700. At this time, the first motive power device 500 synchronously rotates the left clamping member 420 and the right clamping member 410 for jointly clamping the fixed portion 275, that is, the first steering portion 200 cannot rotate about the first axial direction (e.g., Z axis, FIG. 1). In this way, through the execution of the simulation program 712, the operator can rotate the simulation machine 700 about the second axial direction (e.g., R axis) through the second steering portion 300 (FIG. 8B).

Next, when the control circuit 711 determines that the aforementioned specific conditions of the simulation program 712 of the processing host 710 are established, that is, when the timing to simulate the tilting and skidding posture with the somatosensory simulation device 10 is coming, the control circuit 711 instructs the first motive power device 500 to pull back and expand the left clamping member 420 and the right clamping member 410 synchronously, the left clamping member 420 and the right clamping member 410 are unclamped to release the fixed portion 275. Thus, the control circuit 711 can instruct the right driving cylinder 620 and the left driving cylinder 610 to work accordingly in response to the specific signals, so that the first steering portion 200 starts to rotate (FIG. 9B), thereby causing the vehicle body V of the simulation machine 700 to show a tilting and skidding attitude (FIG. 8C).

On the contrary, when the control circuit 711 determines that the aforementioned specific conditions of the simulation program 712 of the processing host 710 are not established, the control circuit 711 instructs the first motive power device 500 to push out and synchronously close the left clamping member 420 and the right clamping member 440 and push the fixed portion 275 to return to the original position (i.e., middle position of the stroke interval G (FIG. 1) to clamp the fixed portion 275 so that the operator can continue to use the simulation program 712 on the simulation machine 700.

Thus, through the construction of the embodiments above, the simulation machine and its somatosensory simulation device of the disclosure are able to provide more natural and smoother body-sensory posture when simulating tilting and slipping postures, thereby advancing the realism and fluency of its simulation so as to improve the interaction between the game machine and the operator.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A somatosensory simulation device, comprising:
a base;
a first steering portion comprising a bracket, a first pivot portion and an extension portion, the bracket that is pivotally connected to the base through the first pivot portion so that the bracket is able to rotate about a first axial direction parallel to a gravity direction, and the extension portion that is connected to the bracket and extending towards the base;
a second steering portion comprising a loading frame and a second pivot portion, the loading frame that is pivotally connected to one side of the bracket opposite to the base through the second pivot portion so that the loading frame is able to rotate about a second axial direction intersecting the second axial direction;
a clamping assembly movably located on the base for clamping the extension portion;
a first motive power device connected to the base and the clamping assembly for driving the clamping assembly to clamp and unclamp the extension portion; and
a second motive power device connected to the base and the bracket for rotating the bracket.

2. The somatosensory simulation device of claim 1, wherein the extension portion comprises:
a main body integrally connected to the bracket; and
a roller pivotally connected to the main body so that the roller is allowed to be rotated about a third axial direction orthogonal to the first axial direction, wherein the roller is movably contacted with the base.

3. The somatosensory simulation device of claim 2, wherein the extension portion further comprises:
a pivot shaft;
a lug extended outwardly from one side of the main body opposite the roller; and
a fixed portion pivotally connected to the lug through the pivot shaft, so as to be clamped and unclamped by the clamping assembly.

4. The somatosensory simulation device of claim 3, wherein the clamping assembly comprises:
a left clamping member pivotably located on the base for rotating about the first axial direction;
a right clamping member symmetrically located on the base with the left clamping member, and pivotably located on the base for rotating about the first axial direction; and
an auxiliary rod body jointly pivoted to the left clamping member and the right clamping member for guiding the left clamping member and the right clamping member to swing symmetrically synchronously, wherein a long axial direction of the auxiliary rod body is orthogonal to the third axial direction,
wherein when the left clamping member and the right clamping member synchronously rotate to approach to each other, the left clamping member and the right clamping member jointly clamp the fixed portion,
when the left clamping member and the right clamping member synchronously rotate away from each other, the left clamping member and the right clamping member jointly unclamp the fixed portion.

5. The somatosensory simulation device of claim 4, wherein when the left clamping member and the right clamping member jointly unclamp the fixed portion, a stroke interval is formed between the left clamping member and the right clamping member, and the fixed portion of the first steering portion which is rotated is still located within the stroke interval,
wherein when the left clamping member and the right clamping member synchronously rotate to approach to each other, one of the left clamping member and the right clamping member pushes the fixed portion back to a previous position before rotation.

6. The somatosensory simulation device of claim 4, wherein the first motive power device further comprises:
a push rod portion pivotally connected to the left clamping member and the right clamping member, respectively, for driving the left clamping member and the right clamping member to synchronously rotate; and
a telescopic cylinder comprising a cylinder main body and a telescopic shaft, one end of the cylinder main body that is fixedly connected to the base, the telescopic shaft that is telescopically disposed within the cylinder main body, and one end of the telescopic shaft is fixedly connected to the push rod portion,
when the telescopic shaft extends along the third axial direction to push the push rod portion outwardly, the push rod portion rotates synchronously the left clamping member and the right clamping member to approach to each other to clamp the fixed portion, and the third axial direction is orthogonal to the first axial direction and a long axial direction of the push rod portion,
when the telescopic shaft retracts along the third axial direction to pull the push rod portion inwardly, the push rod portion rotates synchronously the left clamping member and the right clamping member away from each other to unclamp the fixed portion.

7. The somatosensory simulation device of claim 6, wherein the first motive power device further comprises a third position-limited portion, the third position-limited portion is located on one surface of the cylinder main body facing towards the push rod portion and used to stop the push rod portion.

8. The somatosensory simulation device of claim 6, wherein the clamping assembly further comprises a fourth position-limited portion, the fourth position-limited portion is located on one surface of the auxiliary rod body facing towards the push rod portion and used to stop the push rod portion.

9. The somatosensory simulation device of claim 1, wherein the second motive power device further comprises:
a left driving cylinder having two opposite ends which are pivotally connected to the base and the bracket, respectively; and
a right driving cylinder having two opposite ends which are pivotally connected to the base and the bracket, respectively, and the bracket is located between the left driving cylinder and the right driving cylinder,
wherein when the right driving cylinder extends outwardly to push the bracket and the left driving cylinder retracts inwardly to pull the bracket, the bracket turns left about the first axial direction, when the left driving cylinder extends outwardly to push the bracket and the right driving cylinder retracts inwardly to pull the bracket, the bracket turns right about the first axial direction.

10. The somatosensory simulation device of claim 1, wherein the base further comprises two first position-limited portions, and the first position-limited portions respectively located on two opposite sides of the first pivot portion for stopping a rotation of the bracket so as to limit a rotation range of the bracket.

11. The somatosensory simulation device of claim 1, wherein the bracket further comprises two second position-limited portions, and the second position-limited portions respectively located on two opposite sides of the second pivot portion for stopping a rotation of the loading frame so as to limit a rotation range of the loading frame.

12. The somatosensory simulation device of claim 1, wherein the second steering portion further comprises:
a fixed frame fixed on the bracket; and
an elastic restoring member received within the fixed frame, surrounding the second pivot portion, and respectively abutted with the second pivot portion and the fixed frame for returning the second pivot portion after rotation back to a previous position before rotation.

13. A somatosensory simulation device, comprising:
a base;
a first steering portion comprising a bracket having a frame plate and a platform, a first pivot portion pivotally connected to the base, and an extension portion, one end of the frame plate is fixedly connected to the first pivot portion, so that the frame plate is able to rotate about a first axial direction parallel to a gravity direction through the first pivot portion, the platform that is connected to one side of the frame plate opposite to the base, and the platform that is provided with an inclined surface at one side of the platform opposite to the base, and the extension portion that is connected to the other end of the frame plate and extending towards the base;
a second steering portion comprising a loading frame and a second pivot portion, the loading frame that is pivotally connected to the inclined surface of the platform so that the loading frame is able to rotate about a second axial direction that is parallel to the inclined surface;
a clamping assembly movably located on the base for clamping the extension portion;
a first motive power device connected to the base and the clamping assembly for driving the clamping assembly to clamp and unclamp the extension portion; and
a second motive power device connected to the base and the frame plate for rotating the bracket.

14. The somatosensory simulation device of claim 13, wherein the extension portion comprises:
a main body integrally connected to the frame plate; and
a roller pivotally connected to the main body so that the roller is allowed to be rotated about a third axial direction orthogonal to the first axial direction, wherein the roller is movably contacted with the base.

15. The somatosensory simulation device of claim 14, wherein the extension portion further comprises:
a pivot shaft;
a lug extended outwardly from one side of the main body opposite the roller; and
a fixed portion pivotally connected to the lug through the pivot shaft, so as to be clamped and unclamped by the clamping assembly.

16. The somatosensory simulation device of claim 15, wherein the clamping assembly comprises:
a left clamping member pivotably located on the base for rotating about the first axial direction;
a right clamping member symmetrically located on the base with the left clamping member, and pivotably located on the base for rotating about the first axial direction; and
an auxiliary rod body jointly pivoted to the left clamping member and the right clamping member for guiding the left clamping member and the right clamping member to swing symmetrically synchronously, wherein a long axial direction of the auxiliary rod body is orthogonal to the third axial direction,
wherein when the left clamping member and the right clamping member synchronously rotate to approach to each other, the left clamping member and the right clamping member jointly clamp the fixed portion, when the left clamping member and the right clamping member synchronously rotate away from each other, the left clamping member and the right clamping member jointly unclamp the fixed portion.

17. The somatosensory simulation device of claim 16, wherein when the left clamping member and the right clamping member jointly unclamp the fixed portion, a stroke interval is formed between the left clamping member and the right clamping member, and the fixed portion of the first steering portion which is rotated is still located within the stroke interval,
wherein when the left clamping member and the right clamping member synchronously rotate to approach to each other, one of the left clamping member and the right clamping member pushes the fixed portion back to a previous position before rotation.

18. The somatosensory simulation device of claim 16, wherein the first motive power device further comprises:
a push rod portion pivotally connected to the left clamping member and the right clamping member, respectively, for driving the left clamping member and the right clamping member to synchronously rotate; and
a telescopic cylinder comprising a cylinder main body and a telescopic shaft, one end of the cylinder main body that is fixedly connected to the base, the telescopic shaft that is telescopically disposed within the cylinder main body, and one end of the telescopic shaft is fixedly connected to the push rod portion,
when the telescopic shaft extends along the third axial direction to push the push rod portion outwardly, the push rod portion rotates synchronously the left clamping member and the right clamping member to approach to each other to clamp the fixed portion, and the third axial direction is orthogonal to the first axial direction and a long axial direction of the push rod portion,
when the telescopic shaft retracts along the third axial direction to pull the push rod portion inwardly, the push rod portion rotates synchronously the left clamping member and the right clamping member away from each other to unclamp the fixed portion.

19. A simulation machine, comprising:
the somatosensory simulation device of claim 1;
a vehicle body fixedly installed on the loading frame;
a display unit installed on the vehicle body;
a motorbike controlling circuit installed on the vehicle body; and
a processing host electrically connected to the display unit, the motorbike controlling circuit, the first motive power device and the second motive power device,
wherein when a specific condition of a simulation program of the processing host is established, the processing host instructs the first motive power device to synchronously unclamp the clamping assembly to release the extension portion, and instructs the second motive power device to rotate the bracket so that the vehicle body is allowed to present with a tilting and skidding posture.
